(19) United States
(12) Patent Application Publication
(10) Pub. No.: US 2026/0075334 A1
(43) Pub. Date: Mar. 12, 2026

(54) IMAGE SENSING DEVICE

(71) Applicant: SK hynix Inc., Gyeonggi-do (KR)

(72) Inventors: Gun Hee YUN, Gyeonggi-do (KR); Jeong Ik CHOI, Gyeonggi-do (KR); Han Sol PARK, Gyeonggi-do (KR); Seung Hwan LEE, Gyeonggi-do (KR)

(21) Appl. No.: 19/048,993

(22) Filed: Feb. 10, 2025

(30) Foreign Application Priority Data
Sep. 10, 2024 (KR) 10-2024-0123499

(51) Int. Cl. H04N 25/709; H04N 25/616; H04N 25/78

(52) U.S. Cl. CPC H04N 25/709; H04N 25/78; H04N 25/616

(57) ABSTRACT

An image sensing device includes a ramp signal controller configured to generate a bias voltage; a ramp cell array including a plurality of first ramp cells configured to generate a first ramp signal based on the bias voltage and a plurality of second ramp cells configured to generate a second ramp signal based on the bias voltage; and a load resistor array including a plurality of first load resistors connected to the plurality of first ramp cells and a plurality of second load resistors connected to the plurality of second ramp cells. In a first row of the ramp cell array, the plurality of first ramp cells and the plurality of second ramp cells are arranged alternately in a first direction.

### CROSS-REFERENCE TO RELATED APPLICATION

This patent document claims the priority and benefits of Korean patent application No. 10-2024-0123499, filed on Sep. 10, 2024, the disclosure of which is incorporated by reference in its entirety as part of the disclosure thereof.

### TECHNICAL FIELD

Embodiments of the present disclosure relate to an image sensing device, and more particularly to a ramp signal generator included in an image sensing device.

### BACKGROUND

Generally, a Complementary Metal Oxide Semiconductor (CMOS) Image Sensor (CIS) implemented by a CMOS process has been developed to have lower power consumption, lower costs, and smaller sizes than other competitive products, such that CMOS image sensors have been intensively researched and have rapidly come into widespread use. Specifically, CMOS image sensors have been developed to have higher image quality than other competitive products, such that the application scope of CMOS image sensors has recently been extended to video applications that require higher resolution and higher frame rate as compared to competitive products.

Differently from a solid state image pickup device, it is necessary for the CMOS image sensor to convert analog signals (pixel signals) generated from a pixel array into digital signals. In order to convert analog signals into digital signals, the CMOS image sensor has been designed to include a high-resolution Analog-to-Digital Converter (ADC) therein.

The analog-to-digital converter may perform correlated double sampling about an analog output voltage indicating an output signal of the pixel array, and may store the resultant voltage. In response to a ramp signal generated by the ramp signal generator, the ADC may compare the stored voltage obtained by the correlated double sampling operation with a predetermined reference voltage (ramp signal), such that the ADC may provide a comparison signal for generating a digital code.

### SUMMARY

Various embodiments of the present disclosure are directed to an image sensing device capable of reducing noise or noise deviation of a ramp signal generator included therein, which generates one or more ramp signals.

In accordance with an embodiment of the present disclosure, an image sensing device may include a ramp signal controller configured to generate a bias voltage; a ramp cell array including a plurality of first ramp cells configured to generate a first ramp signal based on the bias voltage and a plurality of second ramp cells configured to generate a second ramp signal based on the bias voltage; and a load resistor array including a plurality of first load resistors connected to the plurality of first ramp cells and a plurality of second load resistors connected to the plurality of second ramp cells. In a first row of the ramp cell array, the plurality of first ramp cells and the plurality of second ramp cells are arranged alternately in a first direction.

In accordance with another embodiment of the present disclosure, an image sensing device may include a ramp signal controller configured to generate a bias voltage; and a ramp cell array including a plurality of first ramp cells configured to generate a first ramp signal based on the bias voltage and a plurality of second ramp cells configured to generate a second ramp signal based on the bias voltage. In the ramp cell array, the plurality of first ramp cells and the plurality of second ramp cells are repeatedly arranged in an order of a first ramp cell, a second ramp cell, a second ramp cell, and a first ramp cell.

In accordance with another embodiment of the present disclosure, an image sensing device may include a ramp signal controller con figured to generate a bias voltage; and a ramp cell array including a first ramp cell group configured to generate a first ramp signal based on the bias voltage and a second ramp cell group configured to generate a second ramp signal based on the bias voltage. A plurality of cells included in the first ramp cell group and a plurality of cells included in the second ramp cell group are arranged alternately in a first direction of the ramp cell array.

It is to be understood that both the foregoing general description and the following detailed description of the present disclosure are illustrative and descriptive and are intended to provide further description of the embodiments as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an imaging system in accordance with some embodiments of the present disclosure.

FIG. 2 is a circuit diagram illustrating a pixel in accordance with some embodiments of the present disclosure.

FIG. 3 is a circuit diagram illustrating an Analog-to-Digital convertor (ADC) in accordance with some embodiments of the present disclosure.

FIG. 4 is a block diagram illustrating a ramp signal generator in accordance with some embodiments of the present disclosure.

FIG. 5 is a block diagram illustrating a common bias voltage generator and a signal generator in accordance with some embodiments of the present disclosure.

FIGS. 6A and 6B are circuit diagrams illustrating a ramp cell array and a load resistor array included in the signal generator in accordance with some embodiments of the present disclosure.

FIGS. 7A and 7B are circuit diagrams illustrating a portion of the ramp cell array and the load resistor array in accordance with some embodiments of the present disclosure.

### DETAILED DESCRIPTION

This present disclosure provides embodiments and examples of a ramp signal generator and an image sensor including the same, that relate to technology for reducing noise or noise deviation generated in the ramp signal generator that may be used in configurations to substantially address one or more technical or engineering issues and to mitigate limitations or disadvantages encountered in some image sensing devices in the art. Some embodiments of the present disclosure relate to a ramp signal generator and an image sensor including the same, which relate to technology for reducing noise or noise deviation generated in a ramp signal generator. Some embodiments of the present disclosure relate to a ramp signal generator capable of reducing noise or noise deviation of a ramp signal generator that generates one or more ramp signals, and an image sensor including the same. In recognition of the issues above, even when one or more ramp signals are used, the image sensing device can generate one or more ramp signals in which signal deviation or noise are improved, thereby increasing the quality of an output image.

Reference will now be made in detail to some embodiments of the present disclosure, examples of which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments will be described with reference to the accompanying drawings. However, it should be understood that the embodiments are not limited to specific embodiments, but includes various modifications, equivalents and/or alternatives of the embodiments. The embodiments of the present disclosure may provide a variety of effects capable of being directly or indirectly recognized.

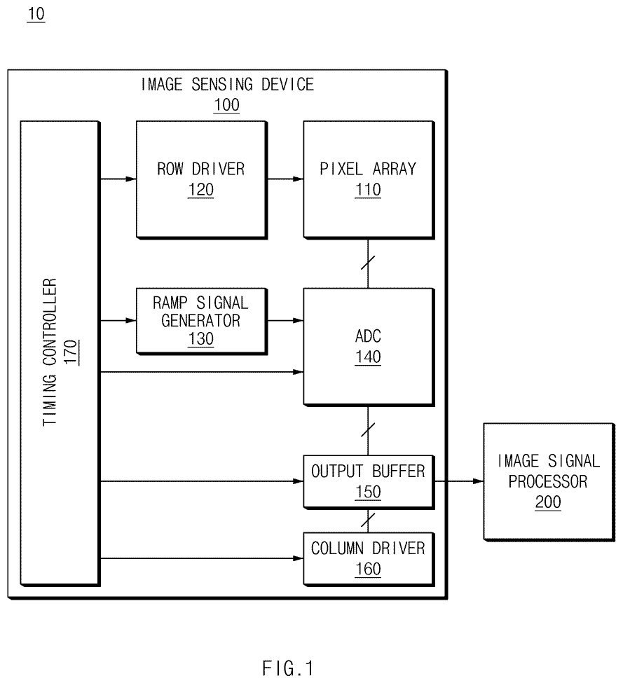

FIG. 1 is a block diagram illustrating an imaging system 10 in accordance with some embodiments of the present disclosure.

Referring to FIG. 1, the imaging system 10 may refer to a device, for example, a digital still camera for photographing still images or a digital video camera for photographing moving images. For example, the imaging system 10 may be implemented as a Digital Single Lens Reflex (DSLR) camera, a mirrorless camera, or a smartphone, and others. The imaging system 10 may include a device having both a lens and an image pickup element such that the device can capture (or photograph) a target object and can thus create an image of the target object.

In some embodiments, the imaging system 10 may include an image sensing device 100 and an image signal processor (ISP) 200.

The image sensing device 100 may be a complementary metal oxide semiconductor image sensor (CIS) for converting incident light into an electrical signal. The image sensing device 100 may include a pixel array 110, a row driver 120, a ramp signal generator 130, an analog-to-digital converter (ADC) 140, an output buffer 150, a column driver 160 and a timing controller 170. The components of the image sensing device 100 illustrated in FIG. 1 are discussed by way of example only, and this present disclosure encompasses numerous other changes, substitutions, variations, alterations, and modifications.

In some embodiments, the pixel array 110 may include a plurality of pixels arranged in rows and columns. In one embodiment, the plurality of pixels can be arranged in a two-dimensional (2D) pixel array including rows and columns. In another embodiment, the plurality of pixels can be arranged in a three dimensional pixel array. The plurality of pixels may convert an optical signal into an electrical signal on a pixel basis or a pixel group basis, where the pixels in a pixel group share at least certain internal circuitry. The pixel array 110 may receive driving signals, including a row selection signal, a pixel reset signal and a transfer signal, from the row driver 120. Upon receiving the driving signal, corresponding imaging pixels in the pixel array 110 may be activated to perform the operations corresponding to the row selection signal, the pixel reset signal, and the transfer signal.

In some embodiments, the row driver 120 may activate the pixel array 110 to perform certain operations on the pixels included in the corresponding row based on commands and control signals provided by the timing controller 170. In some embodiments, the row driver 120 may select one or more imaging pixels arranged in one or more rows of the pixel array 110. The row driver 120 may generate a row selection signal to select one or more rows among the plurality of rows. The row driver 120 may be referred to as a row decoder. The row driver 120 may sequentially enable the pixel reset signal for resetting the pixels corresponding to at least one selected row, and the transfer signal for the pixels corresponding to the at least one selected row. Thus, a reference signal and an image signal, which are analog signals generated by each of the pixels of the selected row, may be sequentially transferred to the ADC 140. The reference signal may be an electrical signal that is provided to the ADC 140 when a sensing node of a pixel (e.g., a floating diffusion region) is reset, and the image signal may be an electrical signal that is provided to the ADC 140 when photocharges generated by the pixel are accumulated in the sensing node. The reference signal indicating unique reset noise of each pixel and the image signal indicating the intensity of incident light may be generically referred to as a pixel signal.

In some embodiments, CMOS image sensors may use Correlated Double Sampling (CDS) to remove undesired offset values of pixels known as the fixed pattern noise by sampling a pixel signal twice to remove the difference between these two samples. In one embodiment, the correlated double sampling (CDS) may remove the undesired offset value of pixels by comparing pixel output voltages obtained before and after photocharges generated by incident light are accumulated in the sensing node so that only pixel output voltages based on the incident light can be measured. In some embodiments of the present disclosure, the ADC 140 may sequentially sample and hold voltage levels of the reference signal and the image signal, which are provided to each of a plurality of column lines from the pixel array 110.

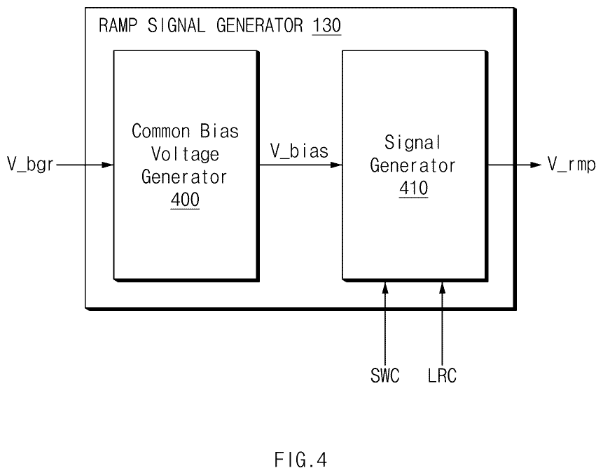

In some embodiments, the ramp signal generator 130 may generate a ramp output signal used for the analog-to-digital conversion operation of the ADC 140 under the control of the timing controller 170, and may supply the ramp output signal to the ADC 140. The ramp signal generator 130 may also be referred to as a ramp generator or a ramp generation circuit. The detailed configuration of the ramp signal generator 130 will be described later with reference to FIG. 4.

In some embodiments, the ADC 140 may sample and hold a pixel signal for each column output from each column line of the pixel array 110, may convert the pixel signal into a digital signal, and may output the digital signal. In some embodiments, the ADC 140 may be implemented as a ramp-compare type ADC that uses the ramp output signal of the ramp signal generator 130. The ramp-compare type ADC may include a comparator circuit for comparing the analog pixel signal with a reference signal such as a ramp output signal that ramps up or down over time, and a counter circuit that perform counting until a voltage of the ramp output signal matches the analog pixel signal. The ADC 140 may perform a counting operation and a computing operation based on the correlate double sampling signal for each of the columns and a ramp output signal provided from the timing controller 170.

In some embodiments, the output buffer 150 may temporarily hold the column-based image data (i.e., data (IDATA) obtained by analog-to-digital conversion of the pixel signal) provided from the ADC 140 to output the image data. In one embodiment, the image data (IDATA) provided to the output buffer 150 from the ADC 140 may be temporarily stored in the output buffer 150 based on control signals of the timing controller 170. The output buffer 150 may provide an interface to compensate for data rate differences or transmission rate differences between the image sensing device 100 and other devices. The output buffer 150 may be referred to as a digital memory.

In some embodiments, the column driver 160 may select a column of the output buffer upon receiving a control signal from the timing controller 170, and sequentially output the image data (IDATA), which are temporarily stored in the selected column of the output buffer 150. In some embodiments, upon receiving an address signal from the timing controller 170, the column driver 160 may generate a column selection signal based on the address signal and select a column of the output buffer 150, outputting the image data (IDATA) as an output signal from the selected column of the output buffer 150. The column driver 160 may be referred to as a column decoder.

In some embodiments, the timing controller 170 may control the row driver 120, the ramp signal generator 130, the ADC 140, the output buffer 150 and the column driver 160. The timing controller 170 may be referred to as a timing and control logic.

In some embodiments, the timing controller 170 may provide the row driver 120, the ramp signal generator 130, the ADC 140, the output buffer 150, and the column driver 160 with a clock signal used for the operations of the respective components of the image sensing device 100, a control signal for timing control, and address signals for selecting a row or column. In an embodiment of the present disclosure, the timing controller 170 may include a logic control circuit, a phase lock loop (PLL) circuit, a timing control circuit, a communication interface circuit and others.

In some embodiments, the image signal processor 200 may perform image processing of image data received from the image sensing device 100. The image signal processor 200 may reduce noise of image data, and may perform various kinds of image signal processing (e.g. interpolation, synthesis, gamma correction, color filter array interpolation, color matrix, color correction, color enhancement, lens distortion correction, etc.) for image-quality improvement of the image data (IDATA). In addition, the image signal processor 200 may compress image data that has been created by execution of image signal processing for image-quality improvement, such that the image signal processor 200 can create an image file using the compressed image data. Alternatively, the image signal processor 200 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

The image signal processor 200 may transmit the ISP image data to a host device (not shown). The host device (not shown) may be a processor (e.g. an application processor) for processing the ISP image data received from the image signal processor 200, a memory (e.g. a non-volatile memory) for storing the ISP image data, or a display device (e.g. a liquid crystal display (LCD)) for visually displaying the ISP image data. In addition, the image signal processor 200 may transmit a control signal for controlling operations (e.g. whether or not to operate, an operation timing, an operation mode, etc.) of the image sensing device 100 to the image sensing device 100.

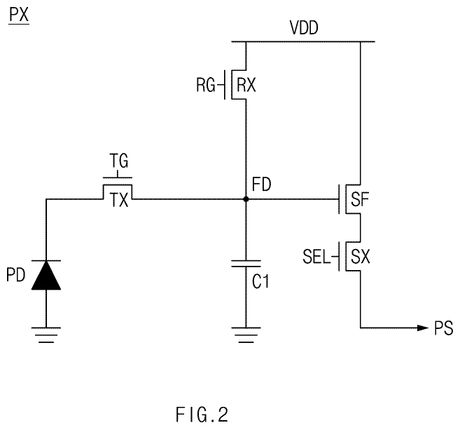

FIG. 2 is a circuit diagram illustrating a pixel (PX) in accordance with some embodiments of the present disclosure.

Referring to FIG. 2, a pixel (PX) may be one of a plurality of pixels included in the pixel array 110, and although FIG. 2 describes only one pixel (PX), other pixels may also have substantially the same structure and operation as those of the pixel (PX).

In some embodiments, the pixel (PX) may include a photoelectric conversion element (PD), a transfer transistor (TX), a reset transistor (RX), a floating diffusion region (FD), a first capacitor (C1), a source follower transistor (SF), and a selection transistor (SX). Although FIG. 4 illustrates that the pixel (PX) includes one photoelectric conversion element PD, the pixel (PX) according to another embodiment may be a shared pixel having a plurality of photoelectric conversion elements. In this case, a plurality of transfer transistors may be provided to correspond to the plurality of photoelectric conversion elements.

In some embodiments, the photoelectric conversion element (PD) may generate and accumulate photocharges corresponding to the intensity of incident light through photoelectric conversion of incident light. For example, the photoelectric conversion element (PD) may be implemented as a photodiode, a phototransistor, a photogate, a pinned photodiode, or a combination thereof.

In some embodiments, when the photoelectric conversion element (PD) is implemented as a photodiode, the photoelectric conversion element (PD) may be a region doped with impurities of a second conductivity type (e.g., N-type) in a substrate having a first conductivity type (e.g., P-type).

In some embodiments, the transfer transistor (TX) may be connected between the photoelectric conversion element (PD) and the floating diffusion region (FD). The transfer transistor (TX) may be turned on or off according to a transfer signal (TG), and the turned-on transfer transistor (TX) may transfer photocharges accumulated in the photoelectric conversion element (PD) to the floating diffusion region (FD).

In some embodiments, the reset transistor (RX) may be connected between the power-supply voltage (VDD) and the floating diffusion region (FD), and may reset a voltage of the floating diffusion region (FD) to the power-supply voltage (VDD) in response to a pixel reset signal (RG).

In some embodiments, the floating diffusion region (FD) may accumulate photocharges received from the transfer transistor (TX). The floating diffusion region (FD) may be connected to a first capacitor (C1) connected to a ground terminal. For example, the floating diffusion region (FD) may be a region doped with impurities of a second conductivity type (e.g., N-type) within a substrate having a first conductivity type (e.g., P-type), and the substrate and the impurity-doped region may be modeled as a first capacitor (C1) which is a junction capacitor. The floating diffusion region (FD) may also be referred to as a sensing node.

In some embodiments, a logic high level may refer to a voltage level for activating (e.g., turning on) a corresponding element (e.g., a transistor), and a logic low level may refer to a voltage level for deactivating (e.g., turning off) a corresponding element (e.g., a transistor).

In some embodiments, although FIG. 2 illustrates the floating diffusion region (FD) having only one capacitance for convenience of description, the scope or spirit of the present disclosure is not limited thereto, and the floating diffusion region (FD) may also have two or more capacitances. For example, the floating diffusion region (FD) may be connected to a dual conversion gain (DCG) transistor to selectively receive additional capacitance, so that the floating diffusion region (FD) may have two capacitances.

In some embodiments, the source follower transistor (SF) may be connected between the power-supply voltage (VDD) and the selection transistor (SX), may amplify a change in electrical potential of the floating diffusion region (FD) that has received photocharges accumulated in the photoelectric conversion element (PD), and may transmit the amplified result to the selection transistor (SX).

In some embodiments, the selection transistor (SX) may be connected between the source follower transistor (SF) and the output signal line, and may be turned on by a selection control signal (SEL), so that the selection transistor (SX) can output the electrical signal received from the source follower transistor (SF) as a pixel signal (PS).

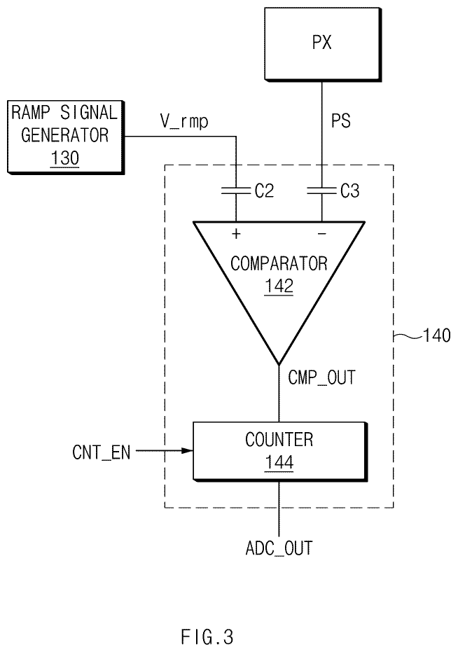

FIG. 3 is a circuit diagram illustrating an analog-to-digital convertor (ADC) 140 in accordance with some embodiments of the present disclosure.

Referring to FIG. 3, the ADC 140 may receive a ramp signal (V_rmp) from the ramp signal generator 130, may receive a pixel signal (PS) from the pixel (PX), may generate ADC data (ADC_OUT) based on the ramp signal (V_rmp) and the pixel signal (PS), and may thus output the ADC data (ADC_OUT).

In some embodiments, the ADC 140 may include a second capacitor (C2), a third capacitor (C3), a comparator 142, and a counter 144.

In some embodiments, the second capacitor C2 may receive the ramp signal (V_rmp), and may transmit the ramp signal (V_rmp) to the comparator 142. The third capacitor C3 may receive the pixel signal (PS), and may transmit the pixel signal (PS) to the comparator 142.

In some embodiments, the comparator 142 may compare the ramp signal (V_rmp) with the pixel signal (PS), may generate comparison data (CMP_OUT) according to the result of comparison, and may transmit the comparison data (CMP_OUT) to the counter 144. In some embodiments, when the ramp signal (V_rmp) is greater than the pixel signal (PS), the comparator 142 may generate comparison data (CMP_OUT) of a logic high level. In addition, if the ramp signal (V_rmp) is less than the pixel signal (PS), the comparator 142 may generate comparison data (CMP_OUT) of a logic low level. That is, the comparison data (CMP_OUT) may represent the magnitude relationship between the ramp signal (V_rmp) and the pixel signal (PS).

In some embodiments, the counter 144 may be activated in response to a counter enable signal (CNT_EN). The activated counter 144 may perform counting in response to the comparison data (CMP_OUT) of a logic high level, and may output the counting result as ADC data (ADC_OUT). Here, the ADC data (ADC_OUT) may correspond to image data (IDATA) described in FIG. 1.

FIG. 4 is a block diagram illustrating a ramp signal generator 130 in accordance with some embodiments of the present disclosure.

Referring to FIG. 4, the ramp signal generator 130 may include a common bias voltage generator 400 and a signal generator 410. In some embodiments, the ramp signal generator 130 may receive a bandgap reference voltage (V_bgr), may generate a ramp signal (V_rmp) used for the analog-to-digital conversion operation of the ADC 140 under the control of the timing controller 170, and may supply the ramp signal (V_rmp) to the ADC 140.

In some embodiments, the common bias voltage generator 400 may generate a bias voltage (V_bias) based on the bandgap reference voltage (V_bgr). In one embodiment, the bandgap reference voltage (V_bgr) may correspond to a reference voltage having a constant voltage level that is hardly subject to fluctuations due to electrical load, time, or temperature changes. In one embodiment, the common bias voltage generator 400 may receive the bandgap reference voltage (V_bgr) from a bandgap reference voltage circuit (not shown) located outside the ramp signal generator 130. In one embodiment, the bias voltage (V_bias) may determine a voltage level that serves as a reference for the ramp signal (V_rmp). For example, the common bias voltage generator 400 may adjust an average voltage level of the ramp signal (V_rmp) by adjusting the bias voltage (V_bias).

In some embodiments, the signal generator 410 may generate a ramp signal (V_rmp) based on a bias voltage (V_bias), a switch control signal (SWC), and a load resistance control signal (LRC). In one embodiment, the switch control signal (SWC) and the load resistance control signal (LRC) may correspond to signals generated by the timing controller 170. In one embodiment, the ramp signal (V_rmp) may be transmitted to the ADC 140, and the ADC 140 may generate and output image data (IDATA) based on the ramp signal (V_rmp) and the pixel signal (PS).

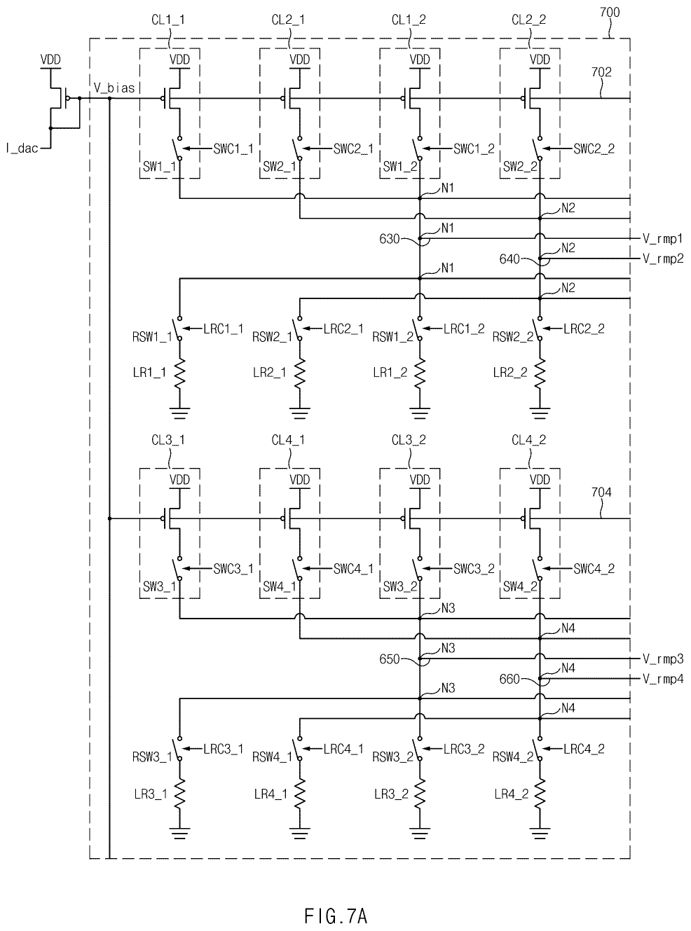

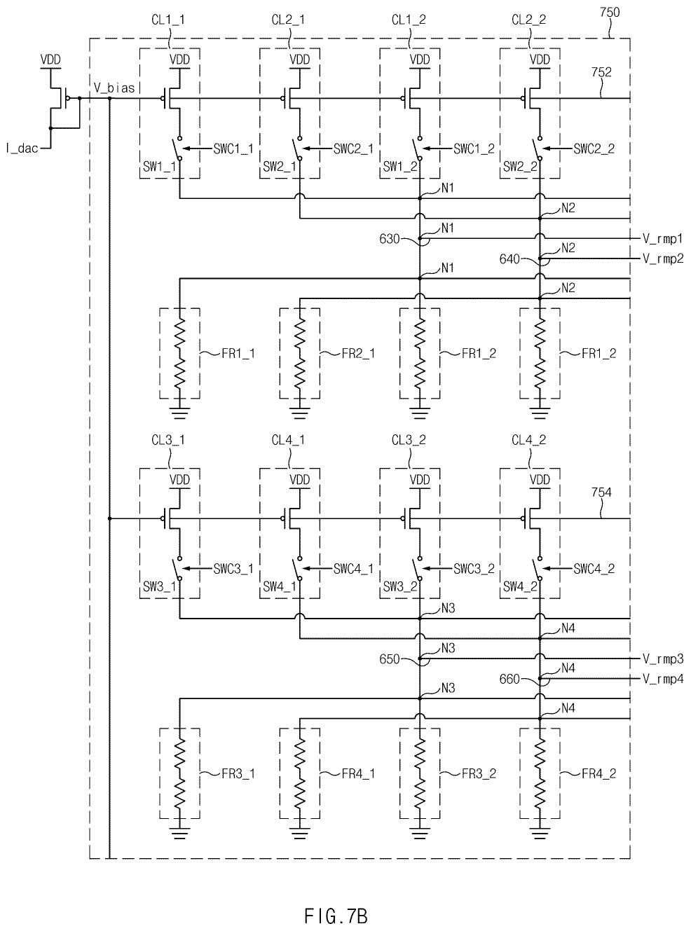

In some embodiments, the switch control signal (SWC) may turn on or off a ramp cell included in the signal generator 410. In one embodiment, the load resistance control signal (LRC) may turn on or off a resistance switch included in the signal generator 410. The signal generator 410 may control a waveform of the ramp signal (V_rmp) based on the switch control signal (SWC) and the load resistance control signal (LRC). A detailed description of the detailed configuration of the signal generator 410 will be given later with reference to FIGS. 7A and 7B.

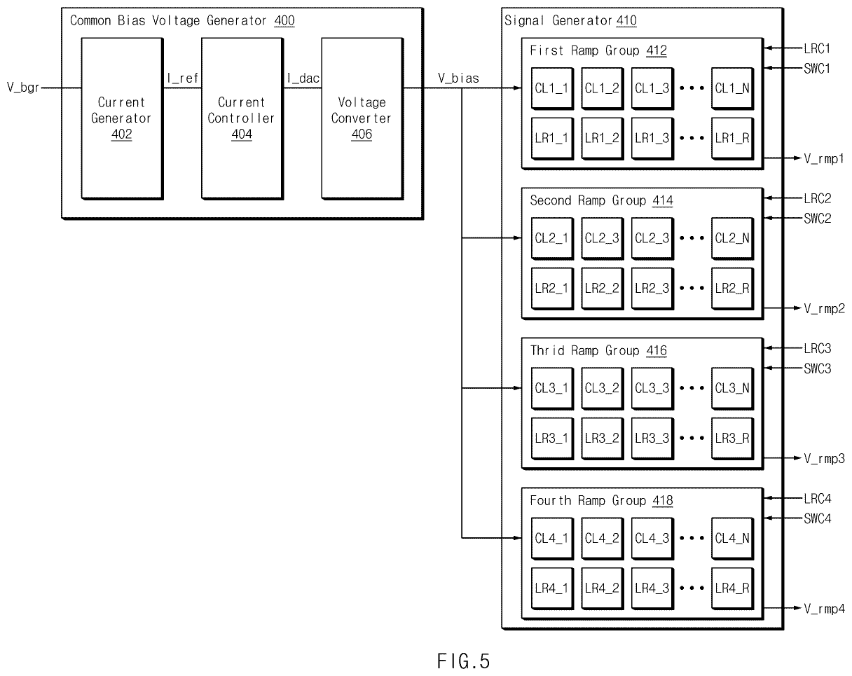

FIG. 5 is a block diagram illustrating the common bias voltage generator 400 and the signal generator 410 in accordance with some embodiments of the present disclosure.

Referring to FIG. 5, the common bias voltage generator 400 may include a current generator 402, a current controller 404, and a voltage converter 406. In one embodiment, the common bias voltage generator 400 may transmit a common bias voltage (V_bias) to the first to fourth ramp groups (412 to 418). In one embodiment, since the first to fourth ramp signals (V_rmp1 to V_rmp4) are generated based on the common bias voltage (V_bias), a signal deviation between the first to fourth ramp signals (V_rmp1 to V_rmp4) may decrease.

In some embodiments, the current generator 402 may generate a reference current (I_ref) based on a bandgap reference voltage (V_bgr). In one embodiment, the current generator 402 may correspond to a circuit that converts an input voltage signal into a current signal. For example, the current generator 402 may include an operational amplifier (OP-AMP)-based voltage-to-current converter, a transistor-based voltage-to-current converter, or an integrated circuit (IC)-based voltage-to-current converter.

In some embodiments, the current controller 404 may generate a digital-to-analog conversion (DAC) current (I_dac) based on a reference current (I_ref). In one embodiment, the DAC current (I_dac) may correspond to a signal that serves as a basis for performing the DAC operation of the ramp signal (V_rmp) by generating the bias voltage (V_bias). For example, the current controller 404 may receive the reference current (I_ref), may adjust the received reference current (I_ref), and may convert the adjusted reference current into the DAC current (I_dac). The DAC current (I_dac) may be a reference signal for determining a ramp offset voltage and/or a swing width of the ramp signal (e.g., V_rmp1). In one embodiment, the current controller 404 may include a current mirror circuit.

In some embodiments, the voltage converter 406 may generate a bias voltage (V_bias) based on the DAC current (I_dac). In one embodiment, the voltage converter 406 may correspond to a circuit that converts an input current signal into a voltage signal. For example, the voltage converter 406 may include a resistive element, an operational amplifier (OP-AMP), a transistor, or an integrated circuit (IC)-based current-to-voltage converter. In one embodiment, the voltage converter 406 may transmit the bias voltage (V_bias) to the first to fourth ramp groups (412 to 418) of the signal generator 410. In one embodiment, some configurations of the voltage converter 406 may form a current mirror circuit together with some configurations of the signal generator 410.

In some embodiments, the signal generator 410 may include one or more ramp groups. For example, the signal generator 410 may include first to fourth ramp groups (412 to 418). In the present embodiment, for convenience of description, the signal generator 410 includes four ramp groups, but the number of ramp groups included in the signal generator 410 is not limited thereto.

In some embodiments, the ramp group may include one or more ramp cells and one or more load resistors. For example, for N, which is an integer greater than or equal to 1, the first ramp group 412 may include N ramp cells (CL1_1 to CL1_N) and N load resistors (LR1_1 to LR1_N). In the present embodiment, the number of ramp cells (e.g., CL1_1 to CL1_N) and the number of load resistors (e.g., LR1_1 to LR1_N) are described as being equal to N, but the embodiments of the present disclosure are not limited thereto. For example, the number of load resistors may be a number greater than or less than N. In the present embodiment, ramp cells included in a ramp group may be grouped into a ramp cell group, and load resistors included in a ramp group may be grouped into a load resistor group. For example, a ramp group may include a ramp cell group and a load resistor group.

In some embodiments, the first ramp group 412 may generate the first ramp signal (V_rmp1) based on the bias voltage (V_bias), the first switch control signal (SWC1), and the first load resistor control signal (LRC1). In one embodiment, a voltage level of the first ramp signal (V_rmp1) may correspond to a potential difference between a ground terminal and a terminal to which a plurality of first ramp cells (CL1_1 to CL1_N) and the plurality of first load resistors (LR1_1 to LR1_N) are connected.

In some embodiments, a waveform of the first ramp signal (V_rmp1) may be formed as the plurality of first ramp cells (CL1_1 to CL1_N) are sequentially turned on or off. For example, when all of the plurality of first ramp cells (CL1_1 to CL1_N) are turned on and the plurality of first ramp cells (CL1_1 to CL1_N) is sequentially turned off by the first switch control signal (SWC1), the voltage level of the first ramp signal (V_rmp1) may be sequentially reduced N times.

In some embodiments, a voltage range of the first ramp signal (V_rmp1) may be determined based on the plurality of first load resistors (LR1_1 to LR1_N). In one embodiment, the plurality of first load resistors (LR1_1 to LR1_N) may perform the same operation as in a variable resistor by the first load resistor control signal (LRC1). For example, each of the plurality of first load resistors (LR1_1 to LR1_N) may be turned on or off by the first load resistor control signal (LRC1), thereby adjusting a resistance level.

In some embodiments, as a resistance value of resistors connected to the plurality of first ramp cells (CL1_1 to CL1_N) becomes smaller, a spacing (i.e., a swing width) between a maximum voltage level and a minimum voltage level of the first ramp signal (V_rmp1) may become smaller. In one embodiment, when the swing width of the first ramp signal (V_rmp1) is relatively small, image data (IDATA) corresponding to a relatively large value for the same pixel signal may be generated. That is, an analog gain may become larger.

In some embodiments, as the resistance value of resistors connected to the plurality of first ramp cells (CL1_1 to CL1_N) becomes larger, the swing width of the first ramp signal (V_rmp1) may become larger. In one embodiment, when the swing width of the first ramp signal (V_rmp1) is relatively large, image data (IDATA) corresponding to a relatively small value for the same pixel signal may be generated. The analog gain may become smaller.

In some embodiments, the signal generator 410 may include a second ramp group 414, a third ramp group 416, and a fourth ramp group 418. In one embodiment, the operations of the second ramp group 414, the third ramp group 416, and the fourth ramp group 418 may be understood in the same manner as those of the first ramp group 412, and as such redundant description thereof will herein be omitted for brevity. In some embodiments, the signal generator 410 may include an additional ramp group in addition to the first to fourth ramp groups (412 to 418), and the operation of the additional ramp group may be understood in the same manner as those of the first ramp group 412. In some embodiments, the first to fourth ramp groups (412 to 418) of the signal generator 410 may share the common bias voltage generator 400, thereby generating a ramp signal with less noise deviation. For example, a configuration in which the first to fourth ramp groups (412 to 418), each of which receives the common bias voltage (V_bias) from the common bias voltage generator 400, may share the remaining components (e.g., a current generator 402, a current controller 404, and a voltage converter 406) other than output components (e.g., the first to fourth ramp groups 412˜418) of the ramp signals, so that a deviation between the first to fourth ramp signals (V_rmp1 to V_rmp4) can be reduced. That is, noise deviation, row-by-row defects, and lattice-shaped defects of image data (IDATA) generated based on the first to fourth ramp signals (V_rmp1 to V_rmp4) and/or linearity defects of transmission/reception (Tx/Rx) signals can be improved.

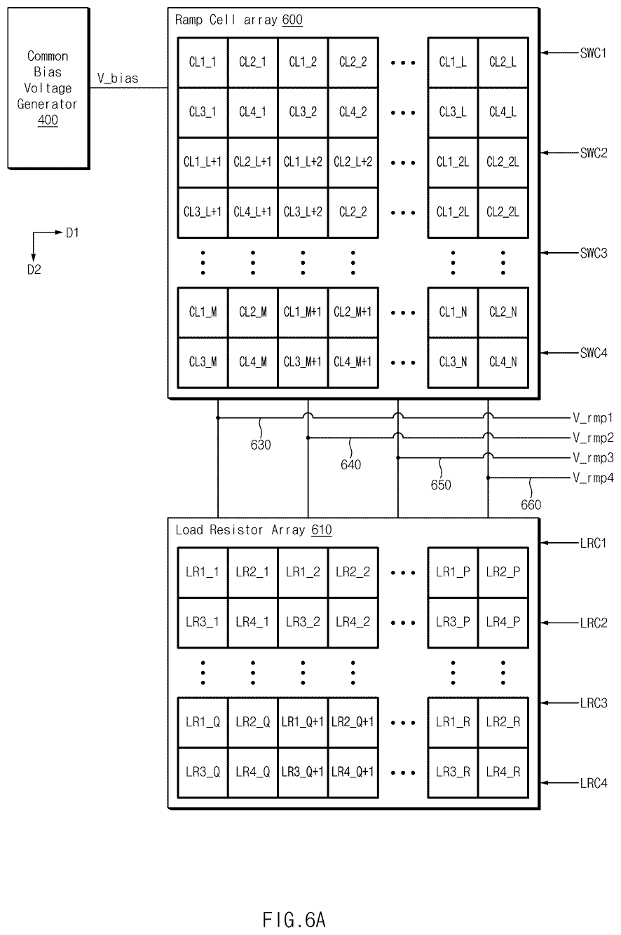

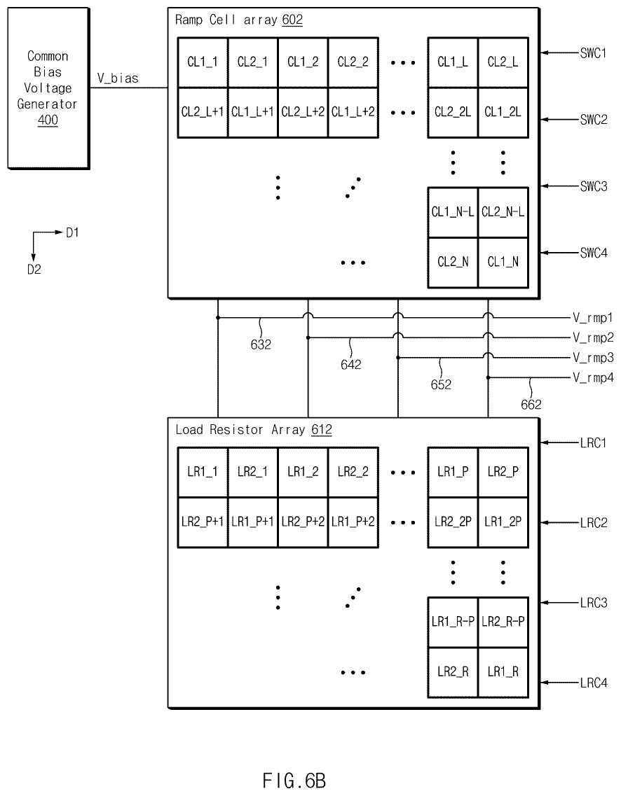

FIGS. 6A and 6B are circuit diagrams illustrating a ramp cell array 600, 602 and a load resistor array 610, 612 included in the signal generator 410 in accordance with some embodiments of the present disclosure.

Referring to FIGS. 5 and 6A, cells (e.g., CL1_1 to CL1_N, CL2_1 to CL2_N, CL3_1 to CL3_N, and CL4_1 to CL4_N) included in the first to fourth ramp groups (412 to 418) of the signal generator 410 may be arranged divisionally in the ramp cell array 600. In one embodiment, load resistors (e.g., LR1_1 to LR1_N, LR2_1 to LR2_N, LR3_1 to LR3_N, and LR4_1 to LR4_N) included in the first to fourth ramp groups (412 to 418) of the signal generator 410 may be arranged divisionally in the load resistor array 610.

In some embodiments, for integers L, M, and N, if “L+M=N+1” and “L<M<N” are satisfied, L first ramp cells (CL1_1 to CL1_L) and L second ramp cells (CL2_1 to CL2_L) may be arranged alternately in the first direction (D1) of the ramp cell array 600 in the first row of the ramp cell array 600. In addition, in the second row of the ramp cell array 600, L third ramp cells (CL3_1 to CL3_L) and L fourth ramp cells (CL4_1 to CL4_L) may be arranged alternately in the first direction (D1) of the ramp cell array 600. In one embodiment, in the third row of the ramp cell array 600, L first ramp cells (e.g., CL1_L+1 to CL1_2L) and L second ramp cells (e.g., CL2_L+1 to CL2_2L) may be arranged alternately in the first direction (D1) of the ramp cell array 600. Additionally, in the fourth row of the ramp cell array 600, L third ramp cells (e.g., CL3_L+1 to CL3_2L) and L fourth ramp cells (e.g., CL4_L+1 to CL4_2L) may be arranged alternately in the first direction (D1) of the ramp cell array 600.

In some embodiments, the mathematical relationship of integers L, M, and N according to the present embodiment is only an example, and the arrangement of the ramp cell array 600 is not limited thereto. For example, referring to FIG. 6A, the equation representing the positions of the ramp cells may satisfy M=L\hat{ }2, M+L=N+1, and L<M<N for the integers L, M, and N.

In some embodiments, the first direction (D1) is only an example of the arrangement direction, and the arrangement of respective components of the present embodiment is not limited to the first direction (D1). For example, L first ramp cells (e.g., CL1_1 to CL1_L) and L second ramp cells (e.g., CL2_1 to CL2_L) may be arranged alternately in the second direction (D2) of the ramp cell array 600. In addition, L third ramp cells (e.g., CL3_1 to CL3_L) and L fourth ramp cells (e.g., CL4_1 to CL4_L) may be arranged alternately in the second direction (D2) of the ramp cell array 600. The arrangement of load resistors, which will be described later, may also be similarly understood.

In some embodiments, in the second row from the last row of the ramp cell array 600 (e.g., the (2N/L-1)th row), a plurality of first ramp cells (e.g., CL1_M to CL1_N) and a plurality of second ramp cells (e.g., CL2_M to CL2_N) may be arranged alternately in the first direction (D1) of the ramp cell array 600. In addition, in the first row (e.g., the 2N/L row) from the last row of the ramp cell array 600, a plurality of third ramp cells (CL3_M to CL3_N) and a plurality of fourth ramp cells (CL4_M to CL4_N) may be arranged alternately in the first direction (D1) of the ramp cell array 600.

In some embodiments, each of the plurality of first ramp cells (CL1_1 to CL1_N) arranged in the ramp cell array 600 may be turned on or turned off in response to the first switch control signal (SWC1). In one embodiment, each of the plurality of second ramp cells (CL2_1 to CL2_N) arranged in the ramp cell array 600 may be turned on or turned off in response to the second switch control signal (SWC2). In one embodiment, each of the plurality of third ramp cells (CL3_1 to CL3_N) arranged in the ramp cell array 600 may be turned on or off according to the third switch control signal (SWC3). In one embodiment, each of the plurality of fourth ramp cells (CL4_1 to CL4_N) arranged in the ramp cell array 600 may be turned on or turned off in response to the fourth switch control signal (SWC4). In the present embodiment, it can be understood that the ramp cell is turned on when the switch included in the ramp cell is closed, and turned off when the switch included in the ramp call is opened. For example, the switch included in the ramp cell may be turned on or off based on a switch control signal. The detailed operation of the switch included in the ramp cell will be described later with reference to FIGS. 7A and 7B.

In some embodiments, the first switch control signal (SWC1) may be understood to collectively refer to the first unit switch control signal (not shown) and the second unit switch control signal (not shown). In one embodiment, one of the plurality of first ramp cells (CL1_1 to CL1_N) may be turned on based on the first unit switch control signal (not shown), and another one of the plurality of first ramp cells (CL1_1 to CL1_N) may be turned on with a time difference based on the second unit switch control signal (not shown).

In some embodiments, when N is an integer, the first unit switch control signal (not shown) to the N-th unit switch control signal (not shown) may be generated by the timing controller 170 in response to the number (e.g., N) of the first ramp cells (CL1_1 to CL1_N). At this time, the first unit switch control signal (not shown) to the N-th unit switch control signal (not shown) may be collectively referred to as the first switch control signal (SWC1). The above-described collective definition may also be applied to the second switch control signal (SWC2), the third switch control signal (SWC3), and the fourth switch control signal (SWC4). A detailed description of the unit switch control signals will be given later with reference to FIGS. 7A and 7B.

In some embodiments, each of the plurality of ramp cells arranged in the ramp cell array 600 may be turned on or off according to the overall switch control signal (not shown). In one embodiment, at least one signal of the first to fourth switch control signals (SWC1 to SWC4) may correspond to the same signal. For example, the plurality of first ramp cells (CL1_1 to CL1_N) and the plurality of second ramp cells (CL2_1 to CL2_N) arranged in the ramp cell array 600 may be turned on or turned off according to the first switch control signal (SWC1). For example, the plurality of first ramp cells (CL1_1 to CL1_N), the plurality of second ramp cells (CL2_1 to CL2_N), and the plurality of third ramp cells (CL3_1 to CL3_N) arranged in the ramp cell array 600 may be turned on or turned off according to the first switch control signal (SWC1).

In some embodiments, for integers P, Q, and R, if “P+Q=R+1” and “P<Q<R” are satisfied, then in the first row of the load resistor array 610, P first load resistors (LR1_1 to LR1_P) and P second load resistors (LR2_1 to LR2_P) may be arranged alternately in the first direction (D1) of the load resistor array 610. In addition, in the second row of the load resistor array 610, P third load resistors (LR3_1 to LR3_P) and P fourth load resistors (LR4_1 to LR4_P) may be arranged alternately in the first direction (D1) of the load resistor array 610.

In some embodiments, the mathematical relationship of integers P, Q, and R according to the present embodiment is only an example, and the arrangement of the load resistor array 610 is not limited thereto. For example, referring to FIG. 6A, the equation representing the position of the load resistor may satisfy “Q=P\hat{ }2, Q+P=R+1, P<Q<R” for the integers P, Q, and R.

In some embodiments, it may be understood that the load resistors arranged in the load resistor array 610 are arranged in the same manner as the arrangement order of the plurality of ramp cells. In one embodiment, in the equation “L+M=N+1, L<M<N” representing the arrangement order of the plurality of ramp cells and the equation “P+Q=R+1, P<Q<R” representing the arrangement order of the plurality of load resistors, “L” and “P” may correspond to the same or different numbers. “M”, “Q”, “N, and R” may also correspond to the same or different numbers.

In some embodiments, each of the plurality of first load resistors (LR1_1 to LR1_R) arranged in the load resistor array 610 may be turned on or off according to the first load resistor control signal (LRC1). In one embodiment, each of the plurality of second load resistors (LR2_1 to LR2_R) arranged in the load resistor array 610 may be turned on or off according to the second load resistor control signal (LRC2). In one embodiment, each of the plurality of third load resistors (LR3_1 to LR3_R) arranged in the load resistor array 610 may be turned on or off according to the third load resistor control signal (LRC3). In one embodiment, each of the plurality of fourth load resistors (LR4_1 to LR4_R) arranged in the load resistor array 610 may be turned on or off according to the fourth load resistor control signal (LRC4). In the present embodiment, the load resistor may be understood as being turned on when the switch connected to the load resistor is closed and turned off when the switch connected to the load resistor is opened. For example, the switch connected to the load resistor may be turned on or off based on a switch control signal. A detailed operation of the switch connected to the load resistor will be described later with reference to FIGS. 7A and 7B.

In some embodiments, the first load resistor control signal (LRC1) may be understood as collectively referring to the first unit resistance control signal (not shown) and the second unit resistance control signal (not shown). In one embodiment, one of the plurality of first load resistors (LR1_1 to LR1_R) may be turned on based on the first unit resistance control signal (not shown), and another one of the plurality of first load resistors (LR1_1 to LR1_R) may be turned on with a time difference based on the second unit resistance control signal (not shown).

In some embodiments, when R is an integer, the first unit resistance control signal (not shown) to the R-th unit resistance control signal (not shown) may be generated by the timing controller 170 in response to the number (e.g., R) of the first ramp cells (CL1_1 to CL1_R). At this time, the first unit resistance control signal (not shown) to the N-th unit resistance control signal (not shown) may be collectively referred to as the first load resistance control signal (LRC1). The above collective definition may also be applied to the second load resistance control signal (LRC2), the third load resistance control signal (LRC3), and the fourth load resistance control signal (LRC4). A detailed description of the unit switch control signals will be given later with reference to FIGS. 7A and 7B.

In some embodiments, each of the plurality of load resistors arranged in the load resistor array 610 may be turned on or off according to the overall load resistance control signal (not shown). In one embodiment, at least one signal of the first to fourth load resistor control signals (LRC1 to LRC4) may correspond to the same signal. The plurality of first load resistors (LR1_1 to LR1_R) and the plurality of second load resistors (LR2_1 to LR2_R) arranged in the load resistor array 610 may be turned on or turned off according to the first load resistor control signal (LRC1). The plurality of first load resistors (LR1_1 to LR1_R), the plurality of second load resistors (LR2_1 to LR2_R), and the plurality of third load resistors (LR3_1 to LR3_R) arranged in the load resistor array 610 may be turned on or turned off according to the first load resistor control signal (LRC1).

In some embodiments, first to fourth ramp lines (630, 640, 650, 660) for respectively transmitting first to fourth ramp signals (V_rmp1 to V_rmp4) may be connected to nodes connected between each of ramp cells included in the ramp cell array 600 and each of load resistors connected to the load resistor array 610. For example, the first ramp line 630 for transmitting the first ramp signal (V_rmp1) may be connected to a node connected between a plurality of first ramp cells (CL1_1 to CL1_N) and a plurality of first load resistors (LR1_1 to LR1_R). The above-described connection relationship may be understood as being similarly applied to the second ramp signal (V_rmp2), the third ramp signal (V_rmp3), and the fourth ramp signal (V_rmp4).

In some embodiments, the image sensing device 100 may further include a ramp signal switch (not shown) that selectively connects the first ramp line 630 transmitting the first ramp signal (V_rmp1), a second ramp line 640 transmitting the second ramp signal (V_rmp2), the third ramp line 650 transmitting the third ramp signal (V_rmp3), and/or the fourth ramp line 660 transmitting a fourth ramp signal (V_rmp4) to the ADC 140. In one embodiment, the ramp signal switch (not shown) may selectively transmit the first ramp signal (V_rmp1), the second ramp signal (V_rmp2), the third ramp signal (V_rmp3), or the fourth ramp signal (V_rmp4) to the ADC 140.

In some embodiments, the ramp cell array 600 may be understood as having ramp cells that are included in a ramp group while being arranged according to a common centroid layout. In one embodiment, the common centroid layout refers to a layout in which two or more elements are arranged to have the same centroid, so that the respective elements experience the same environmental condition. In one embodiment, the load resistor array 610 may be understood as having load resistors that are included in a ramp group while being arranged according to a common centroid layout. For example, when the number of ramp cells included in the load resistor array 610 and the number of load resistors are the same, the load resistors corresponding to the ramp cells (e.g., LR1_1 corresponding to CL1_1, and LR2_N corresponding to CL2_N) may be understood as being arranged according to the same layout as those of the respective corresponding ramp cells.

In some embodiments, for integers L, M, and N, if “L+M=N+1” and “L<M<N” are satisfied, then in the first row of the ramp cell array 600, L first ramp cells (CL1_1 to CL1_L) and L second ramp cells (CL2_1 to CL2_L) may be arranged in the same order as the order of the first ramp cell, the second ramp cell, the second ramp cell, and the second ramp cell in the first direction (D1) of the ramp cell array 600.

In addition, in the second row of the ramp cell array 600, L first ramp cells (CL1_1 to CL1_L) and L second ramp cells (CL2_1 to CL2_L) may be arranged in the same order as the order of the second ramp cell, the first ramp cell, the first ramp cell, the second ramp cell in the first direction (D1) of the ramp cell array 600.

That is, the ramp cells of the first ramp group 412 and the ramp cells of the second ramp group 414 may be repeatedly arranged in a group order of 1, 2, 2, 1, ( . . . ) in the first row, and may be repeatedly arranged in a group order of 2, 1, 1, 2, ( . . . ) in the second row.

In some embodiments, each of the plurality of first ramp cells (CL1_1 to CL1_N) arranged in the ramp cell array 600 may be turned on or off according to the first switch control signal (SWC1). In addition, each of the plurality of second ramp cells (CL2_1 to CL2_N) arranged in the ramp cell array 600 may be turned on or off according to the second switch control signal (SWC2).

In some embodiments, for integers P, Q, and R, if “P+Q=R+1” and “P<Q<R” are satisfied, in a first row of the load resistor array 610, P first load resistors (LR1_1 to LR1_P) and P second load resistors (LR2_1 to LR2_P) may be arranged in the same order as the order of the first load resistor, the second load resistor, the second load resistor, the first load resistor in the first direction (D1) of the load resistor array 610.

In addition, in the second row of the load resistor array 610, P first load resistors (LR1_1 to LR1_P) and P second load resistors (LR2_1 to LR2_P) may be arranged in the same order as the order of the second load resistor, the first load resistor, the first load resistor, and the second load resistor. That is, the load resistors of the first ramp group 412 and the load resistors of the second ramp group 414 may be arranged repeatedly in the group order of 1, 2, 2, 1, ( . . . ) in the first row, and may be arranged repeatedly in the group order of 2, 1, 1, 2, ( . . . ) in the second row.

In some embodiments, each of the plurality of first load resistors (LR1_1 to LR1_P) arranged in the load resistor array 610 may be turned on or off according to the first load resistor control signal (LRC1), and each of the plurality of second load resistors (LR2_1 to LR2_P) arranged in the load resistor array 610 may be turned on or off according to the second load resistor control signal (LRC2).

Referring to FIG. 5 and FIG. 6B, cells (e.g., CL1_1 to CL1_N and CL2_1 to CL2_N) included in the first ramp group 412 and the second ramp group 414 of the signal generator 410 may be arranged divisionally in the ramp cell array 602. In one embodiment, the load resistors (e.g., LR1_1 to LR1_P and LR2_1 to LR2_P) included in the first to second ramp groups (412, 414) of the signal generator 410 may be arranged divisionally in the load resistor array 612. In one embodiment, the first ramp line 632, the second ramp line 642, the third ramp line 652, and the fourth ramp line 662 of FIG. 6B may correspond to the first ramp line 630, the second ramp line 640, the third ramp line 650, and the fourth ramp line 660 of FIG. 6A, respectively.

In some embodiments, for integers L and N, when “L<N” is satisfied, in the first row of the ramp cell array 602, L first ramp cells (CL1_1 to CL1_L) and L second ramp cells (CL2_1 to CL2_L) may be arranged alternately in the first direction (D1) of the ramp cell array 602. In addition, in the second row of the ramp cell array 602, L first ramp cells (CL1_L+1 to CL1_2L) and L second ramp cells (CL2_L+1 to CL2_2L) may be arranged alternately in the first direction (D1) of the ramp cell array 602 in a reverse order of the arrangement order of the first row of the ramp cell array 600.

In some embodiments, in the first row of the ramp cell array 602, L first ramp cells (CL1_1 to CL1_L) and L second ramp cells (CL2_1 to CL2_L) may be arranged alternately from the first ramp cell (e.g., CL1_1) in the first direction (D1) of the ramp cell array 602. In addition, in the second row of the ramp cell array 602, L first ramp cells (CL1_L+1 to CL1_2L) and L second ramp cells (CL2_L+1 to CL2_2L) may be arranged alternately from the second ramp cell (e.g., CL2_1) in the first direction (D1) of the ramp cell array 602. That is, the ramp cells of the first ramp group 412 and the ramp cells of the second ramp group 414 may be repeatedly arranged in a group order of 1, 2, 1, 2, ( . . . ) in the first row of the ramp cell array 602, and may be repeatedly arranged in a group order of 2, 1, 2, 1, ( . . . ) in the second row of the ramp cell array 602.

In some embodiments, each of the plurality of first ramp cells (CL1_1 to CL1_N) arranged in the ramp cell array 602 may be turned on or off according to the first switch control signal (SWC1). In one embodiment, each of the plurality of second ramp cells (CL2_1 to CL2_N) arranged in the ramp cell array 602 may be turned on or off according to the second switch control signal (SWC2).

In some embodiments, each of the plurality of ramp cells arranged in the ramp cell array 602 may be turned on or off according to the overall switch control signal (not shown). In one embodiment, the first switch control signal (SWC1) and the second switch control signal (SWC2) may correspond to the same signal. The plurality of first ramp cells (CL1_1 to CL1_N) and the plurality of second ramp cells (CL2_1 to CL2_N) arranged in the ramp cell array 602 may be turned on or off according to the first switch control signal (SWC1).

In some embodiments, for integers P and R, when “P<R” is satisfied, in the first row of the load resistor array 612, P first load resistors (LR1_1 to LR1_P) and P second load resistors (LR2_1 to LR2_P) may be arranged alternately in the first direction (D1) of the load resistor array 612.

In addition, in the second row of the load resistor array 612, P first load resistors (LR1_P+1 to LR1_PL) and P second load resistors (LR2_P+1 to LR2_PL) may be arranged alternately in a reverse order of the arrangement order of the first row of the load resistor array 612 in the first direction (D1) of the load resistor array 612.

In some embodiments, in the first row of the load resistor array 612, P first load resistors (LR1_1 to LR1_P) and P second load resistors (LR2_1 to LR2_P) may be arranged alternately from the first load resistor (e.g., LR1_1) in the first direction (D1) of the load resistor array 612.

In addition, in the second row of the load resistor array 612, P first load resistors (LR1_P+1 to LR1_2P) and P second load resistors (LR2_P+1 to LR2_PL) may be arranged alternately from the second load resistor (e.g., LR2_1) in the first direction (D1) of the load resistor array 612.

That is, the load resistors of the first ramp group 412 and the load resistors of the second ramp group 414 may be arranged repeatedly in the group order of 1, 2, 1, 2, ( . . . ) in the first row of the load resistor array 610, and may be arranged repeatedly in the group order of 2, 1, 2, 1, ( . . . ) in the second row of the load resistor array 610.

In some embodiments, each of the plurality of first load resistors (LR1_1 to LR1_R) arranged in the load resistor array 612 may be turned on or off according to the first load resistor control signal (LRC1). In addition, each of the plurality of second load resistors (LR2_1 to LR2_N) arranged in the load resistor array 612 may be turned on or off according to the second load resistor control signal (LRC2).

In some embodiments, each of the plurality of load resistors arranged in the load resistor array 612 may be turned on or off according to the overall load resistor control signal (not shown). In one embodiment, the first load resistor control signal (LRC1) and the second load resistor control signal (LRC2) may correspond to the same signal. For example, each of the plurality of first load resistors (LR1_1 to LR1_R) and each of the plurality of second load resistors (LR2_1 to LR2_R) arranged in the load resistor array 612 may be turned on or off according to the first load resistor control signal (LRC1).

FIGS. 7A and 7B are circuit diagrams illustrating a portion of the ramp cell array 600 and the load resistor array 610 in accordance with some embodiments of the present disclosure.

Referring to FIGS. 6A and 7A, some of the ramp cells (CL1_1, CL2_1, CL1_2, CL2_2, CL3_1, CL4_1, CL3_2, CL4_2) included in the ramp cell array 600 of FIG. 6A and some of the load resistors (LR1_1, LR2_1, LR1_2, LR3_1, LR3_2, LR4_1, LR4_2) included in the load resistor array 610 may have the same arrangement as the partial region 700 of the circuit of FIG. 7A. In one embodiment, some of the ramp cells (CL1_1, CL2_1, CL1_2, CL2_2, CL3_1, CL4_1, CL3_2, CL4_2) of FIG. 7A and some of the load resistors (LR1_1, LR2_1, LR1_2, LR3_1, LR3_2, LR4_1, LR4_2) may be understood as being arranged according to a common centroid layout in the same manner as in the arrangement described in FIG. 6A.

In some embodiments, one of the plurality of first ramp cells (e.g., CL1_1) may include one or more transistors to which a power-supply voltage (VDD) is applied and one or more switches (e.g., SW1_1), and the bias voltage (V_bias) may be applied to a gate terminal of the transistor through a first bias line 702. At this time, one of the plurality of first ramp cells (e.g., CL1_1) and some circuits of the voltage converter 406 may form a current mirror structure. In one embodiment, one of the plurality of first ramp cells (e.g., CL1_1) may output a mirrored current (I_dac) through the current mirror structure. In one embodiment, the mirrored current (I_dac) may be transmitted to a first node (N1) connected to the plurality of first load resistors (LR1_1 and LR1_2) when the switch (e.g., SW1_1) is closed. Alternatively, the mirrored current (I_dac) may not be transmitted to the first node (N1) when the switch (SW1_1) is opened. In one embodiment, one of the plurality of first switches (e.g., SW1_1) may be opened or closed by a first detailed switch control signal (e.g., SWC1_1).

In some embodiments, the above-described unit switch control signal may correspond to the first detailed switch control signal of FIG. 7A. For example, the first unit switch control signal and the second unit switch control signal may correspond to the first detailed switch control signals (e.g., SWC1_1, SWC1_2) respectively applied to the plurality of first ramp cells. For example, the third unit switch control signal and the fourth unit switch control signal may correspond to the second detailed switch control signals (e.g., SWC2_1, SWC2_2) respectively applied to the plurality of second ramp cells.

In some embodiments, the ramp cell according to the present embodiment may include one first transistor (not shown) to which a power-supply voltage (VDD) is applied, and a bias voltage (V_bias) may be applied to a gate terminal of the first transistor through the first bias line 702. The ramp cell according to the present embodiment may additionally include a second transistor (not shown) connected to the first transistor (not shown), and a cascade voltage may be applied to a gate terminal of the second transistor (not shown).

In some embodiments, referring to FIG. 7A together with FIG. 6A, the first to fourth switch control signals (SWC1 to SWC4) and the first to fourth load resistor control signals (LRC1 to LRC4) may be divided into detailed signals. For example, the first switch control signal (SWC1) may be divided into first detailed switch control signals (e.g., SWC1-1 to SWC1_N), the number of which is equal to the number of the plurality of first ramp cells, according to a clock of the clock signal of the timing controller 170. For example, the first load resistor control signal (LRC1) may be divided into a plurality of first detailed load resistor control signals (e.g., LRC1-1 to LRC1_N), the number of which is equal to the number of the plurality of first load resistors, according to the clock of the clock signal of the timing controller 170. For example, one of the plurality of first switches (e.g., SW1_1) may be opened or closed by the first detailed switch control signal (e.g., SWC1_1). For example, one of the plurality of first resistance switches (e.g., RSW1_1) may be opened or closed by the first detailed load resistance control signal (LRC1_1).

In some embodiments, the above-described unit resistance control signal may correspond to the first detailed load resistance control signal of FIG. 7A. For example, the first unit resistance control signal and the second unit resistance control signal may correspond to the first detailed load resistance control signals (e.g., LRC1_1, LRC1_2) respectively applied to the plurality of first load resistors. For example, the third unit resistance control signal and the fourth unit resistance control signal may correspond to the second detailed load resistance control signals (e.g., LRC2_1, LRC2_2) respectively applied to the plurality of second load resistors.

In some embodiments, the plurality of second ramp cells (CL2_1, CL2_2), the plurality of third ramp cells (CL3_1, CL3_2), and the plurality of fourth ramp cells (CL4_1, CL4_2) illustrated in FIG. 7A may also be understood in the same manner as the plurality of first ramp cells (CL1_1, CL1_2), and as such redundant description thereof will herein be omitted for brevity.

In some embodiments, the voltage level of the first ramp signal (V_rmp1) may be determined based on a voltage formed according to a current passing through the plurality of first load resistors (LR1_1, LR1_2). For example, a voltage level of the first ramp signal (V_rmp1) may increase or decrease as the amount of current passing through the plurality of first load resistors (LR1_1, LR1_2) increases or decreases.

In some embodiments, the voltage level of the first ramp signal (V_rmp1) may be changed based on the turn-on or turn-off operation of the plurality of first ramp cells (CL1_1, CL1_2). In one embodiment, the amount of the mirrored current (I_dac) transmitted to the first node (N1) may be adjusted by opening or closing the plurality of first switches (SW1_1, SW1_2). For example, when the plurality of first ramp cells (CL1_1, CL1_2) that are turned on is sequentially turned off, a voltage level of the first ramp signal (V_rmp1) may sequentially decrease. The above-described sequentially turning-off operation may mean that the individual ramp cells are sequentially turned off, but does not limit the order in which the ramp cells are turned off. For example, the individual ramp cells may be turned off one by one in any order.

In some embodiments, a plurality of first resistance switches (RSW1_1, RSW1_2) may be connected to a first node (N1). In one embodiment, when each of the plurality of first resistance switches (RSW1_1, RSW1_2) having been closed is opened, a resistance level of the entire load resistance that forms the voltage of the first ramp signal (V_rmp1) using the mirrored current (I_dac) may increase. In addition, when each of the plurality of first resistance switches (RSW1_1, RSW1_2) having been opened is closed, a resistance level of the entire load resistance that forms the voltage of the first ramp signal (V_rmp1) together with the mirrored current (I_dac) may decrease. In one embodiment, a resistance level of the entire load resistance may be adjusted as each of the plurality of first resistance switches (RSW1_1, RSW1_2) is opened and closed. That is, the plurality of load resistances may operate like variable resistors.

In some embodiments, when a resistance level of the entire load resistance forming the voltage of the first ramp signal (V_rmp1) by using the mirrored current (I_dac) is reduced, a difference (i.e., a swing width) between a maximum voltage level and a minimum voltage level of the corresponding ramp signal may decrease, and when the resistance level of the entire load resistance increases, the swing width of the corresponding ramp signal may increase. For example, when all of the plurality of open first resistance switches (RSW1_1, RSW1_2) are closed based on the plurality of first detailed load resistance control signals (LRC1_1, LRC1_2), the overall load resistance level may decrease, and the swing width of the first ramp signal (V_rmp1) may decrease.

In some embodiments, the first ramp signal (V_rmp1) may be transmitted to the ADC 140 through the first ramp line 630 connected to the first node (N1). In one embodiment, the second ramp signal (V_rmp2) may be transmitted to the ADC 140 through the second ramp line 640 connected to a second node (N2). In one embodiment, the third ramp signal (V_rmp3) may be transmitted to the ADC 140 through the third ramp line 650 connected to a third node (N3). In one embodiment, the fourth ramp signal (V_rmp4) may be transmitted to the ADC 140 through the fourth ramp line 660 connected to a fourth node (N4).

In some embodiments, the second ramp signal (V_rmp2) generated based on the plurality of second ramp cells (CL2_1, CL2_2) and the plurality of second load resistors (LR2_1, LR2_2) illustrated in FIG. 7A may be similarly understood through the processes of generating the ramp cells, the load resistors, and the ramp signals described above. The third ramp signal (V_rmp3) and the fourth ramp signal (V_rmp4) may also be similarly understood. Redundant description thereof will herein be omitted for brevity.

In some embodiments, referring to FIG. 7A together with FIG. 5, from a node to which the first bias line 702 and one cell (e.g., CL1_1) included in the first ramp group 412 are connected, an odd-numbered node may be connected to a cell included in the second ramp group 414, and an even-numbered node may be connected to a cell included in the first ramp group 412. In one embodiment, from a node to which the second bias line 704 and one cell (e.g., CL3_1) included in the third ramp group 416 are connected, an odd-numbered node may be connected to a cell included in the fourth ramp group 418, and an even-numbered node may be connected to a cell included in the third ramp group 416.

Referring to FIGS. 6A and 7B, some of the ramp cells (CL1_1, CL2_1, CL1_2, CL2_2, CL3_1, CL4_1, CL3_2, CL4_2) included in the ramp cell array 600 shown in FIG. 6A and some of the load resistors (LR1_1, LR2_1, LR1_2, LR3_1, LR3_2, LR4_1, LR4_2) included in the load resistor array 610 may have the same configuration as the partial region 750 of the circuit shown in FIG. 7B. In one embodiment, some of the plurality of first load resistors and the plurality of second load resistors (LR1_1, LR2_1, LR1_2, LR2_2) of the load resistor array 610 shown in FIG. 6A may correspond to the plurality of first fixed resistors and the plurality of second fixed resistors (FR1_1, FR2_1, FR1_2, FR2_2) shown in FIG. 7B. In one embodiment, some of the ramp cells (CL1_1, CL2_1, CL1_2, CL2_2, CL3_1, CL4_1, CL3_2, CL4_2) of FIG. 7B and some of the load resistors (LR1_1, LR2_1, LR1_2, LR3_1, LR3_2, LR4_1, LR4_2) may be understood as being arranged according to a common centroid layout in the same manner as in the arrangement described in FIG. 6A.

In some embodiments, FIG. 7B illustrates one embodiment in which the load resistors (e.g., LR1_1, LR2_1, LR1_2, LR2_2) of FIG. 7A are changed to fixed resistors (e.g., FR1_1, FR2_1, FR1_2, FR2_2). In one embodiment, the first bias line 752 and the second bias line 754 of FIG. 7B may correspond to the first bias line 702 and the second bias line 744 of FIG. 7A. The description of the remaining components may be understood in the same manner as in FIG. 7A, and as such redundant descriptions thereof will herein be omitted for brevity.

In some embodiments, one of the plurality of first ramp cells (e.g., CL1_1) may include one or more transistors to which a power-supply voltage (VDD) is applied and one or more switches (e.g., SW1_1). In addition, the bias voltage (V_bias) may be applied to the gate terminal of the transistor through the first bias line 752. In one embodiment, one of the plurality of first ramp cells (e.g., CL1_1) may include one or more transistors designed to use a cascade bias voltage.

At this time, one of the plurality of first ramp cells (e.g., CL1_1) and some circuits of the voltage converter 406 may form a current mirror structure. In one embodiment, one of the plurality of first ramp cells (e.g., CL1_1) may output a mirrored current (I_dac) through the current mirror structure. In one embodiment, the mirrored current (I_dac) may be transmitted to the first node (N1) to which a plurality of first fixed resistors (FR1_1, FR1_2) is connected when a switch (e.g., SW1_1) is closed. Alternatively, the mirrored current (I_dac) may not be transmitted to the first node (N1) when the switch (SW1_1) is opened. In one embodiment, one of the plurality of first switches (e.g., SW1_1) may be opened or closed by a first detailed switch control signal (e.g., SWC1_1).

In some embodiments, the plurality of second ramp cells (CL2_1, CL2_2), the plurality of third ramp cells (CL3_1, CL3_2), and the plurality of fourth ramp cells (CL4_1, CL4_2) illustrated in FIG. 7B may also be understood in the same manner as the plurality of first ramp cells (CL1_1, CL1_2), and as such redundant description thereof will herein be omitted for brevity.

In some embodiments, the plurality of first fixed resistors (FR1_1, FR1_2) may include one or more series-connected resistor elements. In one embodiment, each of the plurality of first fixed resistors (FR1_1, FR1_2) may have the same resistance level. In one embodiment, with respect to resistance (or resistors) for generating the ramp signal, the fixed resistor elements may be arranged in a layout of the same pattern as the arrangement of the ramp cells. For example, the plurality of first fixed resistors (FR1_1, FR1_2) may be arranged in the same layout as the plurality of first ramp cells (CL1_1, CL1_2). In one embodiment, the plurality of first fixed resistors (FR1_1, FR1_2) may be understood as a single shared resistor shared by the plurality of first ramp cells (CL1_1, CL1_2).

In some embodiments, the second ramp signal (V_rmp2) generated based on the plurality of second ramp cells (CL2_1, CL2_2) and the plurality of second fixed resistors (FR2_1, FR2_2) illustrated in FIG. 7B may also be similarly understood through the processes of generating the ramp cells, the fixed resistors, and the ramp signals. The third ramp signal (V_rmp3) and the fourth ramp signal (V_rmp4) may also be similarly understood, and as such redundant description thereof will herein be omitted for brevity.

As is apparent from the above description, even when one or more ramp signals are used, the image sensing device can generate one or more ramp signals in which signal deviation or noise are improved, thereby increasing the quality of an output image.

The embodiments of the present disclosure may provide a variety of effects capable of being directly or indirectly recognized.

Although a number of illustrative embodiments have been de scribed, it should be understood that modifications and enhancements to the disclosed embodiments and other embodiments can be devised based on what is described and/or illustrated in this present disclosure. Therefore, the scope of the present disclosure should not be limited to the above-described embodiments but should include the equivalents thereof. Furthermore, the embodiments may be combined to form additional embodiments.

What is claimed is:

1. An image sensing device comprising:
a ramp signal controller configured to generate a bias voltage;
a ramp cell array including a plurality of first ramp cells configured to generate a first ramp signal based on the bias voltage and a plurality of second ramp cells configured to generate a second ramp signal based on the bias voltage; and
a load resistor array including a plurality of first load resistors connected to the plurality of first ramp cells and a plurality of second load resistors connected to the plurality of second ramp cells,
wherein, in a first row of the ramp cell array, the plurality of first ramp cells and the plurality of second ramp cells are arranged alternately in a first direction.

2. The image sensing device according to claim 1, wherein, in a first row of the load resistance array, the plurality of first load resistors and the plurality of second load resistors are arranged alternately in the first direction.

3. The image sensing device according to claim 1, wherein the ramp cell array further includes:
a plurality of third ramp cells configured to generate a third ramp signal based on the bias voltage; and
a plurality of fourth ramp cells configured to generate a fourth ramp signal based on the bias voltage.

4. The image sensing device according to claim 3, wherein, in a second row of the ramp cell array, the plurality of third ramp cells and the plurality of fourth ramp cells are arranged alternately in the first direction.

5. The image sensing device according to claim 1, wherein:
in the first row of the ramp cell array, the plurality of first ramp cells and the plurality of second ramp cells are alternately arranged in the first direction, starting from one cell among the plurality of first ramp cells; and
in a second row of the ramp cell array, the plurality of first ramp cells and the plurality of second ramp cells are arranged alternately in the first direction, starting from one cell among the plurality of second ramp cells.

6. The image sensing device according to claim 1, wherein the ramp signal controller includes:
a current generator configured to generate a reference current;
a current controller configured to control the reference current; and
a voltage converter configured to generate the bias voltage based on the controlled reference current.

7. The image sensing device according to claim 1, wherein:
the plurality of first load resistors is configured to constitute a first variable resistor having a resistance level that is adjusted based on a first load resistance control signal; and
the plurality of second load resistors is configured to constitute a second variable resistor having a resistance level that is adjusted based on a second load resistance control signal.

8. The image sensing device according to claim 1, wherein:
ramp cells of the plurality of first ramp cells are sequentially turned on or off to generate a waveform of the first ramp signal; and
ramp cells of the plurality of second ramp cells are sequentially turned on or off to generate a waveform of the second ramp signal.

9. The image sensing device according to claim 8, wherein:
the plurality of first ramp cells includes a first unit ramp cell and a second unit ramp cell;
the first unit ramp cell is turned on or off based on a first unit switch control signal, and the second unit ramp cell is turned on or off with a time difference from the first unit ramp cell based on a second unit switch control signal;
the plurality of second ramp cells includes a third unit ramp cell and a fourth unit ramp cell; and
the third unit ramp cell is turned on or off based on a third unit switch control signal, and the fourth unit ramp cell is turned on or off with a time difference from the third unit ramp cell based on a fourth unit switch control signal.

10. The image sensing device according to claim 1, further comprising:
an analog-to-digital converter (ADC) configured to perform analog-to-digital conversion on a pixel signal by comparing the first ramp signal or the second ramp signal with the pixel signal.

11. The image sensing device according to claim 10, further comprising:
a ramp signal switch configured to transmit the first ramp signal through a first ramp line to the ADC, or transmit the second ramp signal through a second ramp line to the ADC.

12. An image sensing device comprising:
a ramp signal controller configured to generate a bias voltage; and
a ramp cell array including a plurality of first ramp cells configured to generate a first ramp signal based on the bias voltage and a plurality of second ramp cells configured to generate a second ramp signal based on the bias voltage,
wherein, in the ramp cell array, the plurality of first ramp cells and the plurality of second ramp cells are repeatedly arranged in an order of a first ramp cell, a second ramp cell, a second ramp cell, and a first ramp cell.

13. The image sensing device according to claim 12, wherein:
the plurality of first ramp cells is connected to a plurality of first load resistors;
the plurality of second ramp cells is connected to a plurality of second load resistors; and
the plurality of first load resistors and the plurality of second load resistors are repeatedly arranged in an order of a first load resistor, a second load resistor, a second load resistor, and a first load resistor.

14. An image sensing device comprising:
a ramp signal controller configured to generate a bias voltage; and
a ramp cell array including a first ramp cell group configured to generate a first ramp signal based on the bias voltage and a second ramp cell group configured to generate a second ramp signal based on the bias voltage,
wherein a plurality of cells included in the first ramp cell group and a plurality of cells included in the second ramp cell group are arranged alternately in a first direction of the ramp cell array.

15. The image sensing device according to claim 14, wherein the ramp signal controller includes:
a current generator configured to generate a reference current;
a current controller configured to control the reference current; and
a voltage converter configured to generate the bias voltage based on the controlled reference current.

16. The image sensing device according to claim 14, wherein:
the plurality of cells included in the first ramp cell group is connected to a first variable resistor; and
the plurality of cells included in the second ramp cell group is connected to a second variable resistor.

17. The image sensing device according to claim 16, wherein:
the first variable resistor includes a plurality of first load resistors;
the second variable resistor includes a plurality of second load resistors; and
the plurality of first load resistors and the plurality of second load resistors are arranged alternately in the first direction of a load resistor array connected to the ramp cell array.

18. The image sensing device according to claim 16, wherein:
a resistance level of the first variable resistor is adjusted based on a first variable resistor control signal; and
a resistance level of the second variable resistor is adjusted based on a second variable resistor control signal.

19. The image sensing device according to claim 14, wherein:
the plurality of cells included in the first ramp cell group is connected to one or more first shared resistors; and
the plurality of cells included in the second ramp cell group is connected to one or more second shared resistors.

20. The image sensing device according to claim 14, further comprising:
a bias line configured to transmit the bias voltage; and
a node to which the bias line and one cell included in the first ramp cell group are connected,
wherein an odd-numbered node from the node is connected to a cell included in the second ramp cell group, and an even-numbered node from the node is connected to a cell included in the first ramp cell group.
